(19) United States
(12) Patent Application Publication
(10) Pub. No.: US 2026/0267836 A1
(43) Pub. Date: Sep. 10, 2026

(54) FASTER B-TREE INDEX CREATION IN POSTGRESQL

(71) Applicant: Google LLC, Mountain View, CA (US)

(72) Inventors: Vaibhav Jain, Bengaluru (IN); Prathibha Bisarahalli Prabhakar, Bengaluru (IN)

(73) Assignee: Google LLC, Mountain View, CA (US)

(21) Appl. No.: 19/074,378

(22) Filed: Mar. 8, 2025

(51) Int. Cl. G06F 16/21; G06F 16/22; G06F 16/2455

(52) U.S. Cl. CPC G06F 16/217; G06F 16/2246; G06F 16/24554

(57) ABSTRACT

A method includes obtaining table data and determining a plurality of sorted tuple indexes based on the table data. Each respective sorted tuple index includes a plurality of key values. The method includes partitioning each respective sorted tuple index of the plurality of sorted tuple indexes into two or more partitions. Each respective partition includes at least one key value from each of the plurality of sorted tuple indexes. For each respective partition of the two or more partitions, the method includes assigning a corresponding worker node to the respective partition and generating, using the corresponding worker node, a corresponding b-tree sub-index based on the respective partition. The method includes generating, using a leader node, a b-tree index based on the corresponding b-tree sub-index generated for each respective partition of the two or more partitions.

### TECHNICAL FIELD

This disclosure relates to faster b-tree index creation in PostgreSQL.

### BACKGROUND

B-tree indexes are widely used in databases to optimize data retrieval operations. The performance of a database heavily relies on indexes, especially when dealing with large datasets. Indexes allow the system to quickly locate the data that matches a given query, without scanning the entire table. B-trees are particularly well-suited for this purpose due to their ability to efficiently handle search, insertion, and deletion operations. However, the process of creating a b-tree index may be computationally expensive and time-consuming, particularly when indexing large tables. The time it takes to create an index is primarily dependent on the size of the table being indexed. The creation of a b-tree index may also affect the performance of other concurrent operations of the database, such as queries, updates, or backups.

### SUMMARY

One aspect of the disclosure provides a computer-implemented method executed on data processing hardware that causes the data processing hardware to perform operations b-tree index creation. The operations include obtaining table data and determining a plurality of sorted tuple indexes based on the table data. Each respective sorted tuple index includes a corresponding plurality of key values. The operations include partitioning each respective sorted tuple index of the plurality of sorted tuple indexes into two or more partitions. Each respective partition includes at least one key value from each of the plurality of sorted tuple indexes. For each respective partition of the two or more partitions, the operations include assigning a corresponding worker node to the respective partition and generating, using the corresponding worker node, a corresponding b-tree sub-index based on the respective partition. The operations include generating, using a leader node, a b-tree index based on the corresponding b-tree sub-index generated for each respective partition of the two or more partitions.

Implementations of the disclosure may include one or more of the following optional features. In some implementations, determining the plurality of sorted tuple indexes includes determining a plurality of tuple indexes each including a corresponding plurality of key values based on the table data and sorting each respective tuple index of the plurality of tuple indexes based on the corresponding plurality of key values of the respective tuple index. In some examples, partitioning each respective sorted tuple index of the plurality of sorted tuple indexes into the two or more partitions includes determining one or more pivot points based on an initial sorted tuple index of the plurality of sorted tuple indexes and partitioning each respective sorted tuple index of the plurality of sorted tuple indexes into the two or more partitions based on the one or more pivot points. Here, determining the one or more pivot points may include determining the one or more pivot points to equally distribute the corresponding plurality of key values of the initial sorted tuple index across the two or more partitions. In these examples, partitioning each respective sorted tuple index of the plurality of sorted tuple indexes into the two or more partitions further includes determining that partitioning one of the sorted tuple indexes of the plurality of sorted tuple indexes causes an unequal distribution of the corresponding plurality of key values of the one of the sorted tuple indexes across the two or more partitions, determining one or more other pivot points based on the one of the sorted tuple indexes based on determining that partitioning one of the sorted tuple indexes of the plurality of sorted tuple indexes causes an unequal distribution of the corresponding plurality of key values of the one of the sorted tuple indexes across the two or more partitions, and partitioning each respective sorted tuple index of the plurality of sorted tuple indexes into the two or more partitions based on the one or more other pivot points.

Generating the corresponding b-tree sub-index for each respective partition of the two or more partitions occurs in parallel. In some implementations, the two or more partitions include a first partition and a second partition, and each key value of the first partition is less than each key value of the second partition. In some examples, generating the b-tree index includes connecting each corresponding b-tree sub-index generated for each respective partition of the two or more partitions to a root node and connecting layers of each corresponding b-tree sub-index generated for each respective partition of the two or more partitions. In some implementations, generating the corresponding b-tree sub-index based on the respective partition includes generating a first layer and a second layer based on the respective partition and generating the b-tree index includes generating remaining layers of the corresponding b-tree sub-index based on the respective partition. Generating the corresponding b-tree sub-index based on the respective partition includes storing a leftmost page and a rightmost page of each layer of the corresponding b-tree sub-index.

Another aspect of the disclosure provides a system that includes data processing hardware and memory hardware storing instructions that when executed on the data processing hardware causes the data processing hardware to perform operations. The operations include obtaining table data and determining a plurality of sorted tuple indexes based on the table data. Each respective sorted tuple index includes a corresponding plurality of key values. The operations include partitioning each respective sorted tuple index of the plurality of sorted tuple indexes into two or more partitions. Each respective partition includes at least one key value from each of the plurality of sorted tuple indexes. For each respective partition of the two or more partitions, the operations include assigning a corresponding worker node to the respective partition and generating, using the corresponding worker node, a corresponding b-tree sub-index based on the respective partition. The operations include generating, using a leader node, a b-tree index based on the corresponding b-tree sub-index generated for each respective partition of the two or more partitions.

Implementations of the disclosure may include one or more of the following optional features. In some implementations, determining the plurality of sorted tuple indexes includes determining a plurality of tuple indexes each including a corresponding plurality of key values based on the table data and sorting each respective tuple index of the plurality of tuple indexes based on the corresponding plurality of key values of the respective tuple index. In some examples, partitioning each respective sorted tuple index of the plurality of sorted tuple indexes into the two or more partitions includes determining one or more pivot points based on an initial sorted tuple index of the plurality of sorted tuple indexes and partitioning each respective sorted tuple index of the plurality of sorted tuple indexes into the two or more partitions based on the one or more pivot points. Here, determining the one or more pivot points may include determining the one or more pivot points to equally distribute the corresponding plurality of key values of the initial sorted tuple index across the two or more partitions. In these examples, partitioning each respective sorted tuple index of the plurality of sorted tuple indexes into the two or more partitions further includes determining that partitioning one of the sorted tuple indexes of the plurality of sorted tuple indexes causes an unequal distribution of the corresponding plurality of key values of the one of the sorted tuple indexes across the two or more partitions, determining one or more other pivot points based on the one of the sorted tuple indexes based on determining that partitioning one of the sorted tuple indexes of the plurality of sorted tuple indexes causes an unequal distribution of the corresponding plurality of key values of the one of the sorted tuple indexes across the two or more partitions, and partitioning each respective sorted tuple index of the plurality of sorted tuple indexes into the two or more partitions based on the one or more other pivot points.

Generating the corresponding b-tree sub-index for each respective partition of the two or more partitions occurs in parallel. In some implementations, the two or more partitions include a first partition and a second partition, and each key value of the first. partition is less than each key value of the second partition. In some examples, generating the b-tree index includes connecting each corresponding b-tree sub-index generated for each respective partition of the two or more partitions to a root node and connecting layers of each corresponding b-tree sub-index generated for each respective partition of the two or more partitions. In some implementations, generating the corresponding b-tree sub-index based on the respective partition includes generating a first layer and a second layer based on the respective partition and generating the b-tree index includes generating remaining layers of the corresponding b-tree sub-index based on the respective partition. Generating the corresponding b-tree sub-index based on the respective partition includes storing a leftmost page and a rightmost page of each layer of the corresponding b-tree sub-index.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system that executes a b-tree generator.

FIG. 2 is a schematic view of an example tuple generator of the b-tree generator.

FIG. 3 is a schematic view of an example partitioner of the b-tree generator.

FIG. 4 is a schematic view of an example index generator of the b-tree generator.

FIG. 5 is a graphical representation of partitions generated by the b-tree generator.

FIG. 6 is a flowchart of an example arrangement of operations for a computer-implemented method of b-tree index creation.

FIG. 7 is a schematic view of an example computing device that may be used to implement the systems and methods described herein.

Like reference symbols in the various drawings indicate like elements.

### DETAILED DESCRIPTION

A b-tree index is a data structure that organizes data in a hierarchical manner, where each node of the tree includes a set of keys and pointers to child nodes. Nodes in a b-tree index represent the logical structure of the tree, while pages are the physical storage units on disk that store the nodes. The keys are sorted in ascending order within each node, and the pointers divide the key space into subranges. The root node of the tree includes the minimum and maximum keys of the entire index, and the leaf nodes include the actual data records or pointers to the actual data records. A b-tree tree index allows the system to quickly find the data that matches a given query by following the pointers from the root node to the leaf node that includes the desired key. A b-tree index also supports efficient insertion and deletion operations by splitting nodes as needed to maintain the balance and order of the tree.

Creating a b-tree index involves three main steps, which are reading the table data and creating index tuples, sorting the index tuples, and then building the b-tree index. The first step is to scan the table data (i.e., heap) and extract away key values and record identifiers for each row. These values are then combined into index tuples, which are the basic units of the index. The second step is to sort the index tuples according to the key values using any suitable sorting algorithm. Once sorted, the index tuples are divided into pages, which are the units of storage for the index. The third step is to build the b-tree index from the bottom up, starting from the leaf pages and moving up to the root page. In this context, pages refer to the physical storage units that store the nodes of the b-tree. Each page is assigned a page number, which serves as a pointer for the parent page. The parent page includes the minimum and maximum keys of each child page, as well as the page numbers of the child pages. This process is repeated until the root page is created, which includes the minimum and maximum keys of the entire b-tree index, as well as the page numbers of the first-level child pages.

The third step of building the b-tree index is the most time-consuming and resource-intensive part of the index creation process. That is because building the b-tree index requires multiple passes over the sorted index tuples, as well as multiple disk I/O operations to write and read the index pages. The time it takes to build the b-tree index is proportional to the height of the tree, which depends on the number of index tuples, the size of the index keys, and the size of the index pages. The larger the table being indexed, the more index tuples, index pages, and tree levels are needed, and the longer it takes to build the b-tree index. Moreover, the index creation process may interfere with other concurrent operations of the database, such as queries, updates, or backups, by consuming CPU, memory, and disk resources, and by locking the table or portions of the table.

Accordingly, implementations herein are directed towards a b-tree generator that obtains table data and determines a plurality of sorted tuple indexes based on the table data. Each respective sorted tuple index includes a plurality of key values. The b-tree generator partitions each respective sorted tuple index of the plurality of sorted tuple indexes into two or more partitions. Each respective partition includes at least one key value from each of the plurality of sorted tuple indexes. For each respective partition of the two or more partitions, the b-tree generator assigns a corresponding worker node to the respective partition and generates a corresponding b-tree sub-index based on the respective partition using the corresponding worker node. The b-tree generator generates, using a leader node, a b-tree index based on the corresponding b-tree sub-index generated for each respective partition of the two or more partitions.

Generating b-tree sub-indexes in parallel provides significant benefits in the b-tree index creation process, specifically by reducing the overall index creation time and improving hardware resource utilization. By assigning each partition of the sorted tuple indexes to a separate worker node, the system leverages parallel processing to construct multiple sub-indexes simultaneously. The parallelism substantially decreases the latency associated with index creation, especially for large datasets. Moreover, parallel sub-index generation optimizes the usage of available hardware resources, such as CPU cores and memory, across the worker nodes. Distributing the workload across multiple nodes prevents bottlenecks and ensures that each node operates efficiently, leading to a higher overall system throughput. The parallel approach also facilitates better scalability, allowing the system to handle increasing data volumes and index complexities by simply adding more worker nodes. The reduction in index creation time directly translates to improved database responsiveness and faster query execution, enhancing the overall performance of the data management system.

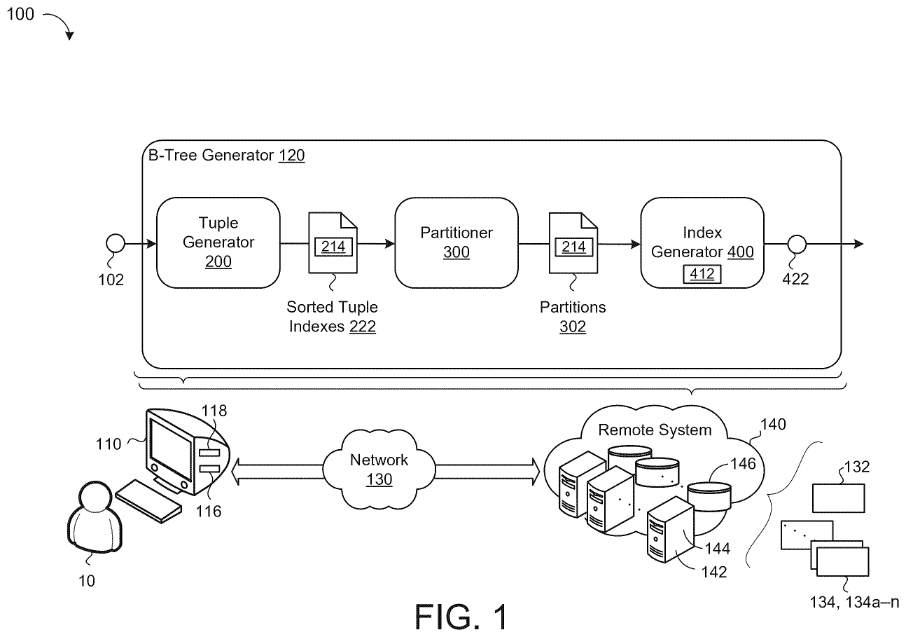

Referring to FIG. 1, in some implementations, a system 100 includes a remote system 140 in communication with one or more user device 110 each associated with a respective user 10 via a network 130, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via the network 130. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware).

The remote system 140 executes a leader node 132 and a plurality of worker nodes 134, 134a-n. The leader node 132 acts as the central coordinator and orchestrator of the remote system 140. Specifically, the leader node 132 is responsible for tasks such as task scheduling, workload distribution, and overall system management. The worker nodes 134 are computational units that execute the tasks assigned by the leader node 132. Each worker node 134 performs the assigned task independently, contributing to the parallel processing of the overall workload. The leader node 132 and the worker nodes 134 are configured to handle specific data processing operations, such as partitioning, sorting, and indexing. In some examples, the leader node 132 is a dedicated node that is solely responsible for the functions of the leader node 132. In other examples, the leader node 132 may be implemented as one of the plurality of worker nodes 134. This means that the leader node 132 may perform the functions of the leader node 132 and one of the plurality of worker nodes 134.

The remote system 140 and/or the user device 110 execute a b-tree generator 120 that is configured to generate b-tree indexes 422. The b-tree generator 120 includes a tuple generator 200, a partitioner 300, and an index generator 400. The tuple generator 200 obtains table data 102 from a database, another source, or automatically as part of a migration request or similar request. For instance, during a database migration, the tuple generator 200 may automatically extract the necessary table data 102 to ensure a seamless transition without manual intervention. Alternatively, the tuple generator 200 may receive the table data 102 from the user device 110. The table data 102 represents records in a table that need to be indexed. These records may include various types of data such as customer information, transaction records, or product inventories, which are important for efficient database querying and management.

The tuple generator 200 determines a plurality of sorted tuple indexes 222 based on the table data 102. Each sorted tuple index 222 is a data structure that stores a plurality of key values 214 of the records in the table data 102. For example, in a customer database, the key values 214 may be customer IDs, and record identifiers are unique row numbers or pointers to the actual data records. The key values 214 are the values of the key columns of the table. These key columns are typically used for indexing purposes, such as primary keys or unique identifiers, which help to quickly locate corresponding records in the database. Record identifiers are the values that uniquely identify the records in the table, such as row numbers, pointers, or hashes. The tuple generator 200 may generate one or more sorted tuple indexes 222, depending on the size and distribution of the table data 102. For example, the tuple generator 200 may generate multiple sorted tuple indexes 222 to optimize performance across different worker nodes 134, ensuring efficient data retrieval and load balancing.

In some instances, the leader node 132 and a selected number of worker nodes 134 generate a corresponding sorted tuple index 222. Notably, the tuple generator 200 determines which, and how many, worker nodes 134 to select, and not necessarily all available worker nodes 134 are selected. This approach allows for parallel processing of data, where the leader node 132 and each worker node 134 handles a subset of the data, significantly speeding up the index creation process. Specifically, each node, whether the leader node 132 or a worker node 134, receives a portion of the table data 102 and extracts the key values 214 from the data. The node then sorts the key values 214 to create a sorted list, which represents the sorted tuple index 222. For example, if the table data 102 includes customer records with customer IDs as key values, a worker node 134 may receive a subset of these records, extract the customer IDs, sort the extracted records by customer ID, and store the sorted records as a sorted tuple index 222.

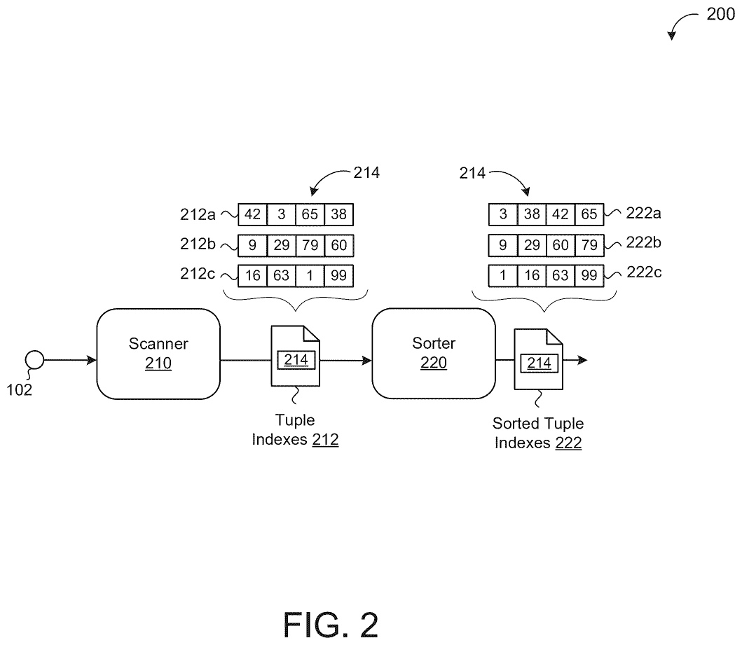

Referring now to FIG. 2, in some implementations, the tuple generator 200 includes a scanner 210 and a sorter 220. The scanner 210 is responsible for the initial extraction of data from the table data 102 and the creation of unsorted tuple indexes 212. Specifically, the scanner 210 accesses the table data 102 and reads the records sequentially or in parallel and extracts the designated key values 214 for each record. The scanner 210 constructs a tuple index 212 for each subset of the data processed. These tuple indexes 212 are initially unsorted, meaning the key values 214 within the tuple indexes 212 are in the order the key values 214 were read from the table data 102. In the example shown, the scanner 210 uses three nodes (e.g., the leader node 132 and two worker nodes 134 or three worker nodes 134) to generate three tuple indexes 212, 212a-c based on the table data 102. Here, each node may generate the corresponding tuple index 212 in parallel (i.e., concurrently with generating the other tuple indexes 212). In this example, the first tuple index 212a includes the key values 214 of [42, 3, 65, 38], the second tuple index 212b includes the key values 214 of [9, 29, 79, 60], and the third tuple index 212c includes the key values 214 of [16, 63, 1, 99].

Following the creation of the unsorted tuple indexes 212, the sorter 220 organizes the data into sorted sequences. Put another way, the sorter 220 sorts each respective tuple index 212 of the plurality of tuple indexes 212 based on the corresponding plurality of key values 214 of the respective tuple index 212 to generate the plurality of sorted tuple indexes 222. That is, the sorter 220 iterates through each tuple index 212 generated by the scanner 210 and applies a sorting algorithm, such as quicksort, mergesort, or radix sort, to arrange the key values 214 in ascending or descending order. Continuing with the example shown, the sorter 220 generates three sorted tuple indexes 222, 222a-c. Similar to the scanner 210, the sorter 220 may use three nodes to generate the three sorted tuple indexes 222. Here, the first sorted tuple index 222a includes the key values 214 of [3, 38, 42, 65], the second sorted tuple index 222b includes the key values 214 of [9, 29, 60, 79], and the third sorted tuple index 222c includes the key values 214 of [1, 16, 63, 99]. Notably, the sorted tuple indexes 222 are a sorted version of the tuple indexes 212. The sorter 220 may also employ parallel sorting techniques, distributing the sorting workload across multiple nodes to further accelerate the process. For instance, each worker node 134 may sort the tuple index that the respective worker node 134 generated concurrently with each other worker node 134.

Referring back to FIG. 1, the partitioner 300 partitions each respective sorted tuple index 222 of the plurality of sorted tuple indexes 222 into two or more partitions 302. In particular, the partitioner 300 divides the sorted tuple indexes 222 into smaller, manageable chunks, or partitions 302, to facilitate parallel processing and efficient data distribution of data across worker nodes 134. Each respective partition 302 includes at least one key value 214 from each of the plurality of sorted tuple indexes 222. For instance, each respective partition 302 may include a range of key values 214. Here, the partitioner 300 may use a range-based partitioning strategy. In range-based partitioning, the partitioner 300 divides the key value 214 space into non-overlapping ranges. For example, if the sorted tuple indexes 222 contain customer IDs ranging from 1 to 1000, the partitioner 300 may create ten partitions 302, with the first partition 302 including IDs from 1 to 100, the second partition 302 including IDs from 101 to 200, and so on. As such, creating the partitions 302 ensures a relatively even distribution of key values 214 across partitions 302, particularly when the key values 214 are uniformly distributed. However, when data skew exists, the partitioner 300 may employ techniques like adaptive partitioning or sampling to adjust the partition boundaries and maintain load balance.

The particular partitioning strategy may be tailored based on various factors, such as the number of available worker nodes 134, the size of each sorted tuple index 222, and the desired level of parallelism. Notably, the number of worker nodes 134 that process the partitions 302 may be different or the same as the number of worker nodes 134 that created the plurality of sorted tuple indexes 222. For example, three worker nodes 134 may generate the sorted tuple indexes 222 while six worker nodes 134 process the partitions 302. This allows for increased parallelism during processing of the partitions 302, potentially improving overall performance, especially when dealing with large datasets or complex partitioning logic. Alternatively, the same three worker nodes 134 that generated the sorted tuple indexes 222 may be used to process the partitions 302.

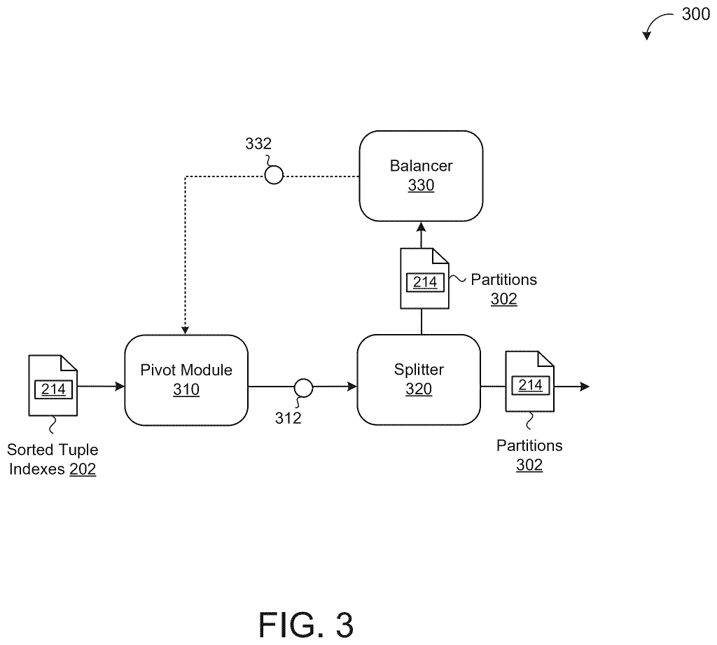

Referring now to FIG. 3, in some implementations, the partitioner 300 includes pivot module 310, a splitter 320, and a balancer 330. The pivot module 310 determines one or more pivot points 312 based on an initial sorted tuple index 222 of the plurality of sorted tuple indexes 222. For instance, the pivot module 310 may determine the one or more pivot points 312 based on the first sorted tuple index 222. The pivot module 310 may determine the number of pivot points 312 based on the number of nodes (e.g., the leader node 132 and the worker nodes 134) that will process the partitions 302. In particular, the number of pivot points 312 may be equal to the number of nodes that will process the partitions 302 minus one. For example, to partition the sorted tuple indexes 222 into two partitions 302, the pivot module 310 identifies a median point from one of the sorted tuple indexes 222 as the one pivot point 312. The pivot module 310 may then use the one pivot point 312 to split all the sorted tuple indexes 222 into two partitions 302.

In another example, to partition the sorted tuple indexes 222 into three partitions 302, the pivot module identifies two points from one of the sorted tuple indexes 222 that evenly distributes the key values 214 among the three partitions 302 as the two pivot points 312. For instance, the pivot module 310 may determine the 33^{rd} and 66^{th} percentiles of the key values 214 from the one of the sorted tuple indexes 222 to identify the two pivot points 312. Thereafter, the pivot module 310 may then use the two pivot points 312 to split all the sorted tuple indexes 222 into three partitions 302. The pivot points 312 represent the boundaries between the partitions 302, ensuring that each partition 302 includes a distinct range of key values 214. This approach ensures that the partitions 302 are balanced, meaning that the partitions 302 include a similar number of key values 214, which helps distribute the workload evenly across the worker nodes.

Continuing with the example from FIG. 2, the pivot module 310 may determine a pivot point 312 corresponding to the key value 214 of “39” based on the first sorted tuple index 222a. Here, the pivot point 312 of “39” ensures that key values 314 [3, 38] are in one partition 302 and key values 214 [42, 65] are in another partition 302.

The splitter 320 partitions each respective sorted tuple index 222 of the plurality of sorted tuple indexes 222 into the two or more partitions 302 based on the one or more pivot points 312. In particular, the splitter 320 compares each key value 214 within a sorted tuple index 222 against the one or more pivot points 312. For a single pivot point scenario, all key values 214 less than or equal to the pivot point 312 are placed into a first partition 302, and all key values 214 greater than the pivot point 312 are placed into a second partition 302. Thus, each key value 214 in the first partition 302 is less than each key value 214 of the second partition 302. In a multi-pivot point 312 scenario, the key values are distributed based on their relative position to the range defined by each pair of adjacent pivot points 312. For example, if two pivot points 312 are determined, the key values 214 are placed into three partitions 302. In this example, the first partition 302 includes key values 214 less than or equal to the first pivot point 312, the second partition 302 includes key values greater than the first pivot point 312 and less than or equal to the second pivot point 312, and the third partition 302 includes key values 214 greater than the second pivot point 312. For example, using the pivot point of “39” from the prior example, the splitter 320 would process each sorted tuple index 222.

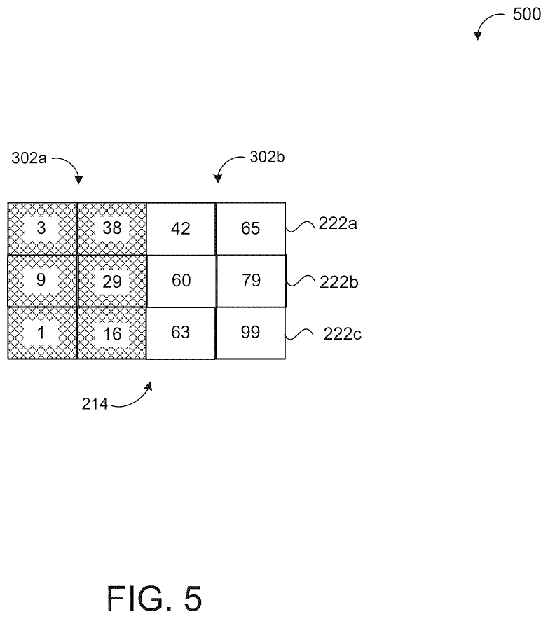

FIG. 5 includes a graphical view 500 of the partitions 302 created by the partitioner 300 from FIG. 3. Here, for the first sorted tuple index 222a, which includes the key values 214 of [3, 38, 42, 65], the splitter 320 compares each key value 214 to the pivot point 312 of “39.” The splitter 320 places [3, 38] in the first partition 302 (depicted by the hatched boxes) since these key values 214 are less than “39” and [42, 65] into the second partition 302 (depicted by the unhatched boxes) since these key values 214 are greater than “39.” Similarly, for the second sorted tuple index 222b, which includes the key values 214 of [9, 29, 60, 79], the splitter 320 compares each key value 214 to the pivot point 312 of “39.” Thus, the splitter 320 places [9, 29] into the first partition 302 and [60, 79] into the second partition 302. Moreover, for the third sorted tuple index 222c, which includes the key values 214 of [1, 16, 63, 99], the splitter 320 compares each key value 214 to the pivot point 312 of “39.” Thus, the splitter 320 places [1, 16] into the first partition 302 and [63, 99] into the second partition 302. Accordingly, in this example, the splitter 320 successfully divides each sorted tuple index 222 into two partitions 302 based on the pivot point 312, ensuring that key values 214 are distributed according to their relationship to the pivot point 312. If, however, two pivot points 312 were used, such as 20 and 60, then the first sorted tuple index 222a would be split into three partitions 302. The first partition 302 would include the key value 214 of [3], the second partition 302 would include the key values 214 of [38, 42], and the third partition 302 would include the key values 214 of [65]. The splitter 320 would repeat this process for the remaining sorted tuple indexes 222.

Referring again to FIG. 3, the balancer 330 determines whether partitioning of the plurality of sorted tuple indexes 222 causes an unequal distribution of the corresponding plurality of key values 214 among the partitions 302 or not. That is, the balancer 330 evaluates the distribution of key values 214 across the generated partitions 302 by determining whether the number of key values 214 assigned to each partition 302 is approximately equal. However, it is understood that an exactly equal distribution of key values 214, as depicted in FIG. 5, is not strictly required. Instead, the balancer 330 may operate within a predetermined threshold of equalness. The threshold allows for minor variations in the number of key values 214 assigned to each partition 302, recognizing that perfect balance may not always be achievable or necessary for optimal performance. Specifically, the balancer 330 may allow for a certain percentage difference or absolute difference in the number of key values 214 across the partitions 302 before triggering a re-balancing operation.

On the other hand, when the balancer 330 determines that partitioning of one of the sorted tuple indexes 222 of the plurality of sorted tuple indexes 222 causes an unequal distribution of the corresponding plurality of key values 214 (e.g., fails to satisfy the threshold) of the one of the sorted tuple indexes across the two or more partitions, the balancer 330 sends a notification 332 to the pivot module 310. Upon receiving the notification 332, the pivot module 310 re-evaluates the key value 214 distribution potentially using a different sorted tuple index as a basis for determining a new set of pivot points 312. Thereafter, the splitter 320 partitions each respective sorted tuple index 222 of the plurality of sorted tuple indexes 222 into the two or more partitions 302 based on the one or more other pivot points 312. The iterative process of balancing and re-partitioning continues until a relatively even distribution of key values 214 across the partitions 302 is achieved, ensuring optimal load balancing during subsequent processing stages.

Referring back to FIG. 1., for each respective partition 302 of the two or more partitions 302, the index generator 400 assigns a corresponding worker node 134 to the respective partition 302 and generates, using the corresponding worker node 134, a corresponding b-tree sub-index 412 based on the respective partition 302. Thereafter, the index generator 400 generates, using the leader node 132, a b-tree index 422 based on the corresponding b-tree sub-index 412 generated for each respective partition of the two or more partitions 302. Specifically, the index generator 400 distributes the workload of building the final b-tree index 422 across the worker nodes 134. Each worker node 134 is responsible for creating a smaller b-tree, referred to as b-tree sub-index 412, from the data within the partition 302 assigned to the worker node 134. For example, if there are six partitions 302, the index generator 400 may assign each partition to a different worker node 134. Notably, the generation of each b-tree sub-index 412 by each respective worker node 134 occurs in parallel, meaning that the worker nodes 134 generate the corresponding b-tree sub-indexes 412 simultaneously. The parallel execution significantly reduces the overall time required to generate the final b-tree index 422, as opposed to a sequential process where each sub-index 412 is generated one after the other. Advantageously, the parallel generation of the b-tree sub-indexes 412 leverages the computational resources of multiple worker nodes 134 to expedite the indexing process, thereby improving the efficiency and scalability of the remote system 140.

Each of these six worker nodes 134 may then independently, and concurrently, generate a b-tree sub-index 412 for the respective partition 302. Once all the worker nodes 134 have generated the corresponding b-tree sub-indexes 412, the leader node 132 merges the corresponding b-tree sub-indexes 412 into a single b-tree index 422. The final b-tree index 422 represents the complete sorted index for the entire table data 102. The merging process at the leader node 132 involves combining the multiple B-tree sub-indexes 412 while maintaining the sorted order of the key values 214.

The assignment process employed by the index generator 400 may be performed using various strategies, including a round-robin approach, a hash-based approach, or a workload-based approach. In the round-robin approach, the index generator 400 cycles through the available worker nodes 134 sequentially, assigning each partition 302 to the next available worker node 134. For example, if there are four worker nodes 134, the first partition 302 is assigned to the first worker node 134, the second partition 302 is assigned to the second worker node 134, and so on. Once the fourth partition 302 is assigned to the fourth worker node 134, the fifth partition 302 is assigned back to the first worker node 134. In the hash-based approach, the index generator 400 uses a hash function to map each partition 302 to a specific worker node 134. The hash function takes the key values 214 or other relevant information of the partition 302 as input and generates a hash value that corresponds to a worker node. Thus, the hash function ensures that each partition 302 is consistently assigned to the same worker node 134, even if the order of the partitions 302 changes. The hash function takes the key values 214 of the partition 302 as input and generates a hash value that corresponds to a worker node 134. In the workload-based approach, the index generator 400 monitors the current workload of each worker node 134 and assigns each partition 302 to the worker node 134 with the least amount of work. This dynamic approach ensures that the workload is evenly distributed across all worker nodes 134, preventing any single worker node 134 from becoming a bottleneck. Thus, the workload-based approach aims to balance the workload across all worker nodes 134 and minimize the overall index creation time.

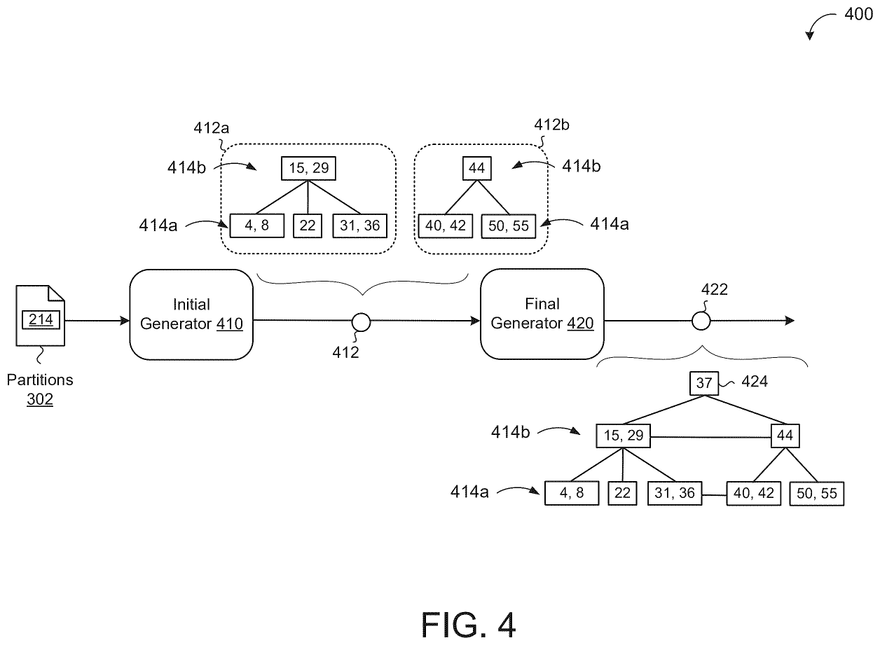

FIG. 4 illustrates an example index generator 400 which may include an initial generator 410 and a final generator 420. The initial generator 410 obtains the two or more partitions 302 and generates the corresponding b-tree sub-index 412 based on the respective partition 302 using the corresponding assigned worker node 134. In the example shown, the initial generator 410 generates two corresponding b-tree sub-indexes 412a, 412b. In some examples, the initial generator 410 stores a leftmost page and a rightmost page of each layer 414 of each corresponding b-tree sub-index 412. The storage of boundary pages allows for efficient navigation and merging during the final index construction by the final generator 420. That is, the initial generator 410 distributes the workload of constructing the lower portions of the b-tree index 422 across the worker nodes 134. Each worker node 134, guided by the initial generator 410, is responsible for creating a b-tree sub-index 412 from the data within the assigned partition 302. Each corresponding b-tree sub index 412 may include one or more layers 414. These layers 414 form the hierarchical structure of the b-tree, where each layer 414 includes nodes or pages that include pointers to nodes or pages in the immediately lower or upper layer 414.

The final generator 420 consolidates the multiple b-tree sub-indexes 412 into a single b-tree index 422, which represents the complete sorted index for the entire table data 102. In some examples, the final generator 420 generates the b-tree index 422 by connecting each corresponding b-tree sub-index 412 to a root node 424. More specifically, the final generator 420 generates the root node 424 that includes pointers to the topmost node of each b-tree sub-index 412. That is, the final generator 420 creates the root node 424, which includes pointers to the topmost nodes of each b-tree sub-index 412, thereby establishing the top-level structure of the final b-tree index 422. Moreover, the final generator 420 may connect layers 414 of each corresponding b-tree sub-index to create a continuous hierarchical structure from the lower layers 414 generated by the worker nodes 134 to the root node 424.

In some examples, the initial generator 410 generates each corresponding b-tree sub-index by generating a first layer 414a and a second layer 414b based on the respective partition 302. That is, each worker node 134 may construct only the bottom two layers 414 of the b-tree sub-index 412, effectively handling the lower-level data organization. In these examples, the final generator 420 generates the b-tree index 422 by generating remaining upper layers 414 of each corresponding b-tree sub index 412. Thus, the final generator 420 focuses on the higher-level structural organization of the b-tree index 422, leveraging the pre-processed lower layers 414 generated by the worker nodes 134 to complete the index construction. The final generator 420 effectively builds the upper layers 414 of the b-tree index 422, connecting the lower layers 414 generated by the worker nodes 134 to the root node 424, thereby forming the complete b-tree index 422.

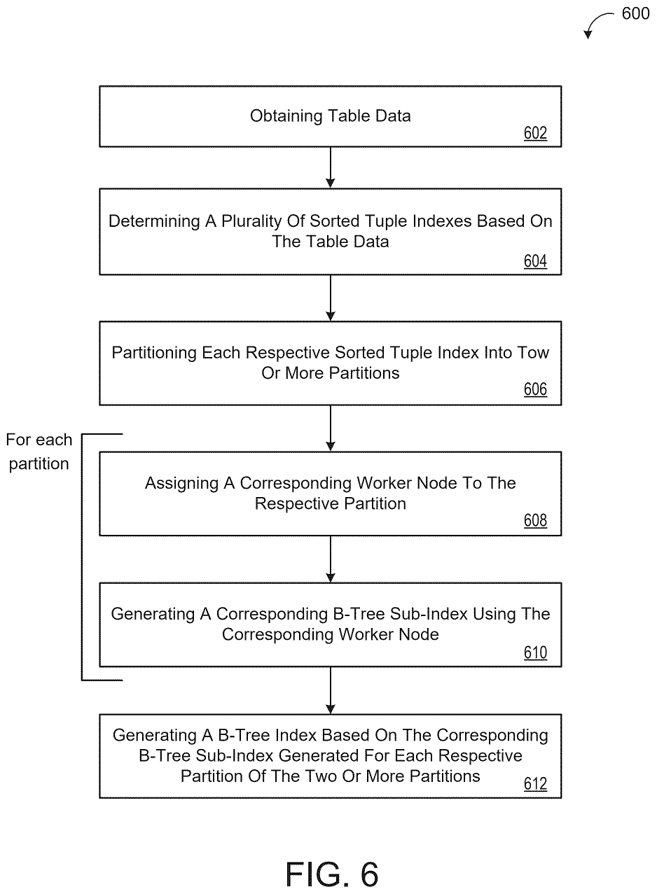

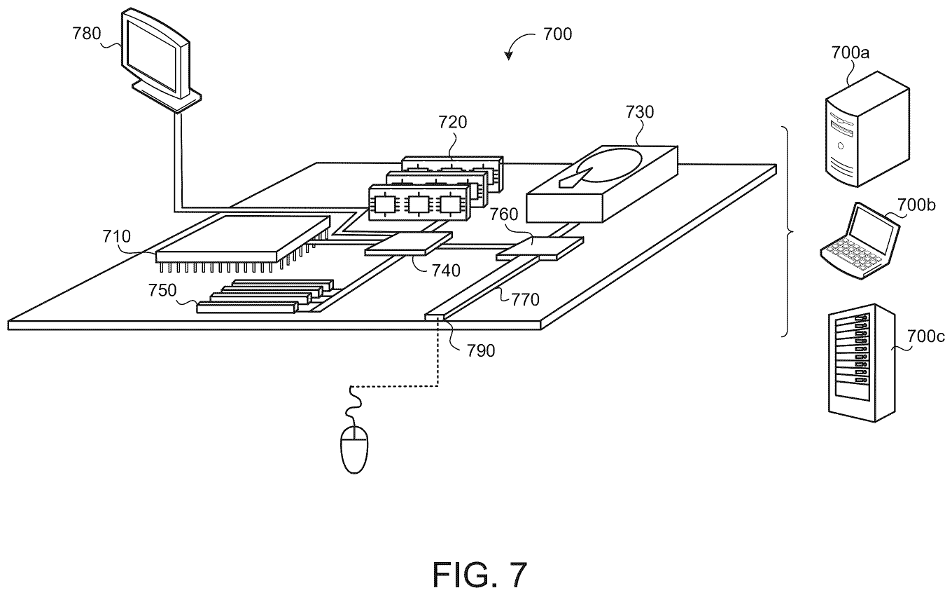

FIG. 6 includes a flowchart of an example arrangement of operations for a computer-implemented method 600 of b-tree index creation. The method 600 may execute on data processing hardware 710 (FIG. 7) using instructions stored on memory hardware 720 (FIG. 7) that may reside on the user device 110 and/or the remote system 140 of FIG. 1 each corresponding to a computing device 700 (FIG. 7).

At operation 602, the method 600 includes obtaining table data 102. At operation 604, the method 600 includes determining a plurality of sorted tuple indexes 222 based on the table data 102. Each respective sorted tuple index 222 includes a corresponding plurality of key values 214. At operation 606, the method 600 includes partitioning each respective sorted tuple index 222 of the plurality of sorted tuple indexes 222 into two or more partitions 302. Each respective partition 302 includes at least one key value 214 from each of the plurality of sorted tuple indexes 222. For each respective partition 302 of the two or more partitions 302 the method 600 performs operations 608 and 610. At operation 608, the method 600 includes assigning a corresponding worker node 134 to the respective partition 302. At operation 610, the method 600 includes generating, using the corresponding worker node 134, a corresponding b-tree sub-index 412 based on the respective partition 302. At operation 612, the method 600 includes generating, using a leader node 132, a b-tree index 422 based on the corresponding b-tree sub-index 412 generated for each respective partition 302 of the two or more partitions 302.

Advantageously, generating b-tree sub-indexes 412 in parallel provides significant benefits in the b-tree index 422 creation process. By assigning each partition 302 of the sorted tuple indexes 222 to a separate worker node 134, the b-tree generator 120 leverages parallel processing to construct multiple b-tree sub-indexes 412 simultaneously. The parallelism substantially decreases the latency associated with index creation, especially for large datasets. Moreover, parallel b-tree sub-index 412 generation optimizes the usage of available hardware resources, such as CPU cores and memory, across the worker nodes 134. Distributing the workload across multiple nodes prevents bottlenecks and ensures that each node operates efficiently, leading to a higher overall system throughput. The parallel approach also facilitates better scalability, allowing the system to handle increasing data volumes and index complexities by simply adding more worker nodes. The reduction in index creation time directly translates to improved database responsiveness and faster query execution, enhancing the overall performance of the data management system.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A method comprising:
obtaining, by data processing hardware, table data;
based on the table data, determining, by the data processing hardware, a plurality of sorted tuple indexes, each respective sorted tuple index comprising a corresponding plurality of key values;
partitioning, by the data processing hardware, each respective sorted tuple index of the plurality of sorted tuple indexes into two or more partitions, each respective partition comprising at least one key value from each of the plurality of sorted tuple indexes;
for each respective partition of the two or more partitions:
assigning, by the data processing hardware, a corresponding worker node of the data processing hardware to the respective partition; and
generating, by the corresponding worker node, a corresponding b-tree sub-index based on the respective partition; and
generating, by leader node of the data processing hardware, a b-tree index based on the corresponding b-tree sub-index generated for each respective partition of the two or more partitions.

2. The method of claim 1, wherein determining the plurality of sorted tuple indexes comprises:
based on the table data, determining, by the data processing hardware, a plurality of tuple indexes, each respective tuple index comprising a corresponding plurality of key values; and
sorting, by the data processing hardware, each respective tuple index of the plurality of tuple indexes based on the corresponding plurality of key values of the respective tuple index.

3. The method of claim 1, wherein partitioning each respective sorted tuple index of the plurality of sorted tuple indexes into the two or more partitions comprises:
determining, by the data processing hardware, one or more pivot points based on an initial sorted tuple index of the plurality of sorted tuple indexes; and
partitioning, by the data processing hardware, each respective sorted tuple index of the plurality of sorted tuple indexes into the two or more partitions based on the one or more pivot points.

4. The method of claim 3, wherein determining the one or more pivot points comprises determining, by the data processing hardware, the one or more pivot points to equally distribute the corresponding plurality of key values of the initial sorted tuple index across the two or more partitions.

5. The method of claim 1, wherein partitioning each respective sorted tuple index of the plurality of sorted tuple indexes into the two or more partitions comprises:
determining, by the data processing hardware, one or more pivot points based on an initial sorted tuple index of the plurality of sorted tuple indexes;
determining, by the data processing hardware, that partitioning one of the sorted tuple indexes of the plurality of sorted tuple indexes causes an unequal distribution of the corresponding plurality of key values of the one of the sorted tuple indexes across the two or more partitions;
based on determining that partitioning one of the sorted tuple indexes of the plurality of sorted tuple indexes causes an unequal distribution of the corresponding plurality of key values of the one of the sorted tuple indexes across the two or more partitions, determining, by the data processing hardware, one or more other pivot points based on the one of the sorted tuple indexes; and
partitioning, by the data processing hardware, each respective sorted tuple index of the plurality of sorted tuple indexes into the two or more partitions based on the one or more other pivot points.

6. The method of claim 1, wherein generating the corresponding b-tree sub-index for each respective partition of the two or more partitions occurs in parallel.

7. The method of claim 1, wherein:
the two or more partitions comprise a first partition and a second partition; and
each key value of the first partition is less than each key value of the second partition.

8. The method of claim 1, wherein generating the b-tree index comprises:
connecting, by the leader node, each corresponding b-tree sub-index generated for each respective partition of the two or more partitions to a root node; and
connecting, by the leader node, layers of each corresponding b-tree sub-index generated for each respective partition of the two or more partitions.

9. The method of claim 1, wherein:
generating the corresponding b-tree sub-index based on the respective partition comprises generating, by the corresponding worker node, a first layer and a second layer based on the respective partition; and
generating the b-tree index comprises generating, by the leader node, remaining layers of the corresponding b-tree sub-index based on the respective partition.

10. The method of claim 1, wherein generating the corresponding b-tree sub-index based on the respective partition comprises storing, by the corresponding worker node, a leftmost page and a rightmost page of each layer of the corresponding b-tree sub-index.

11. A system comprising:
data processing hardware; and
memory hardware in communication with the data processing hardware, the memory hardware storing instructions that when executed on the data processing hardware cause the data processing hardware to:
obtain table data;
based on the table data, determine a plurality of sorted tuple indexes, each respective sorted tuple index comprising a corresponding plurality of key values;
partition each respective sorted tuple index of the plurality of sorted tuple indexes into two or more partitions, each respective partition comprising at least one key value from each of the plurality of sorted tuple indexes;
for each respective partition of the two or more partitions:
assign a corresponding worker node of the data processing hardware to the respective partition; and
generate, by the corresponding worker node, a corresponding b-tree sub-index based on the respective partition; and
generate, by a leader node of the data processing hardware, a b-tree index based on the corresponding b-tree sub-index generated for each respective partition of the two or more partitions.

12. The system of claim 11, wherein, to determine the plurality of sorted tuple indexes, the instructions cause the data processing hardware to:
based on the table data, determine a plurality of tuple indexes, each respective tuple index comprising a corresponding plurality of key values; and
sort each respective tuple index of the plurality of tuple indexes based on the corresponding plurality of key values of the respective tuple index.

13. The system of claim 11, wherein, to partition each respective sorted tuple index of the plurality of sorted tuple indexes into the two or more partitions, the instructions cause the data processing hardware to:
determine one or more pivot points based on an initial sorted tuple index of the plurality of sorted tuple indexes; and
partition each respective sorted tuple index of the plurality of sorted tuple indexes into the two or more partitions based on the one or more pivot points.

14. The system of claim 13, wherein, to determine the one or more pivot points, the instructions cause the data processing hardware to determine the one or more pivot points to equally distribute the corresponding plurality of key values of the initial sorted tuple index across the two or more partitions.

15. The system of claim 11, wherein, to partition each respective sorted tuple index of the plurality of sorted tuple indexes into the two or more partitions, the instructions cause the data processing hardware to:
determine one or more pivot points based on an initial sorted tuple index of the plurality of sorted tuple indexes;
determine that partitioning one of the sorted tuple indexes of the plurality of sorted tuple indexes causes an unequal distribution of the corresponding plurality of key values of the one of the sorted tuple indexes across the two or more partitions;
based on determining that partitioning one of the sorted tuple indexes of the plurality of sorted tuple indexes causes an unequal distribution of the corresponding plurality of key values of the one of the sorted tuple indexes across the two or more partitions, determine one or more other pivot points based on the one of the sorted tuple indexes; and
partition each respective sorted tuple index of the plurality of sorted tuple indexes into the two or more partitions based on the one or more other pivot points.

16. The system of claim 11, wherein the data processing hardware generates the corresponding b-tree sub-index for each respective partition of the two or more partitions in parallel.

17. The system of claim 11, wherein:
the two or more partitions comprise a first partition and a second partition; and
each key value of the first partition is less than each key value of the second partition.

18. The system of claim 11, wherein, to generate the b-tree index, the instructions cause the leader node of the data processing hardware to:
connect each corresponding b-tree sub-index generated for each respective partition of the two or more partitions to a root node; and
connect layers of each corresponding b-tree sub-index generated for each respective partition of the two or more partitions.

19. The system of claim 11, wherein:
to generate the corresponding b-tree sub-index based on the respective partition, the instructions cause the corresponding worker node of the data processing hardware to generate a first layer and a second layer based on the respective partition; and
to generate the b-tree index, the instructions cause the leader node of the data processing hardware to generate remaining layers of the corresponding b-tree sub-index based on the respective partition.

20. The system of claim 11, wherein, to generate the corresponding b-tree sub-index based on the respective partition, the instructions cause the corresponding worker node of the data processing hardware to store a leftmost page and a rightmost page of each layer of the corresponding b-tree sub-index.
